(19) United States
(12) Patent Application Publication
(10) Pub. No.: US 2010/0025612 A1
(43) Pub. Date: Feb. 4, 2010

(54) CONTROL VALVE FOR A WATER TAP

(76) Inventor: Chang-Hua TASI, Lugang Town (TW)

Correspondence Address: Dr. BANGER SHIA;Int''l Patent Office of Bang Shia, 102 Lindencrest Ct, Sugar Land, TX, 77479-5201, US

(21) Appl. No.: 12/185,090

(22) Filed: Aug. 2, 2008

(51) Int. Cl. F16K 1/02

(52) U.S. Cl. 251/318

(57) ABSTRACT

A control valve for a water tap comprises a connecting member, a drain member, and a stop assembly, wherein the drain member is screwed with the connecting member, and between the drain member and the connecting member is defined a passage, the drain member includes a plurality of outlets formed on the bottom thereof for communicating with the passage and for flowing water outwardly, the stop assembly is defined between the connecting member and the drain member, such that as the drain member is rotated to the first position, the water flows out of the outlets through the passage, and as the drain member is rotated to the second position, the stop assembly closes the passage to stop water flow, controlling water supply easily from an outlet extension of the water tap.

### BACKGROUND OF THE INVENTION

1. Field of the Invention

The present invention relates to a control valve for a water tap.

2. Description of the Prior Art

A conventional control knob is disposed on the upper end of the water pipe for controlling water supply. As washing hands, the user has to hold water with hands and then spray water in his hands to the control knob, thus cleaning the control knob; however, such a cleaning method will waste water.

The present invention has arisen to mitigate and/or obviate the afore-described disadvantages.

### SUMMARY OF THE INVENTION

The primary objective of the present invention is to provide a control valve for a water tap that can control water supply easily from an outlet extension of the water tap.

A further objective of the present invention is to provide a control valve for a water tap that can save water effectively.

Another objective of the present invention is to provide a control valve for a water tap that can be produced at lower cost and in less time.

A control valve for a water tap comprises a connecting member, a drain member, and a stop assembly, wherein the drain member is screwed with the connecting member, and between the drain member and the connecting member is defined a passage, the drain member includes a plurality of outlets formed on the bottom thereof for communicating with the passage and for flowing water outwardly, the stop assembly is defined between the connecting member and the drain member, such that as the drain member is rotated to the first position, the water flows out of the outlets through the passage, and as the drain member is rotated to the second position, the stop assembly closes the passage to stop water flow.

The various objects and advantages of the present invention will be more readily understood from the following detailed description when read in conjunction with the appended drawing.

### BRIEF DESCRIPTION OF THE DRAWINGS

FIG. 1 is a perspective view illustrating a control valve for a water tap of the present invention being assembled to a water tap;

FIG. 2A is a perspective view illustrating the exploded components of a control valve for a water tap in accordance with a first embodiment of the present invention; and

FIG. 2B is a perspective view illustrating the assembly of a drain member of a control valve for a water tap in accordance with a second embodiment of the present invention;

FIG. 3A is a cross sectional view illustrating the operation of the control valve for the water tap in accordance with the first embodiment of the present invention; and

FIG. 3B is another cross sectional view illustrating the operation of the control valve for the water tap in accordance with the first embodiment of the present invention; and

FIG. 3C is a cross sectional view taken along lines C-C of FIG. 3B;

FIG. 4A is a cross sectional view illustrating the operation of a projection and a retaining slot of the control valve for the water tap in accordance with the first embodiment of the present invention; and

FIG. 4B is another cross sectional view illustrating the operation of the projection and the retaining slot of the control valve for the water tap in accordance with the first embodiment of the present invention;

FIG. 5A is a cross sectional view illustrating the operation of the control valve for the water tap in accordance with the second embodiment of the present invention; and

FIG. 5B is another cross sectional view illustrating the operation of the control valve for the water tap in accordance with the second embodiment of the present invention;

FIG. 6A is a cross sectional view illustrating the operation of a control valve for a water tap in accordance with a third embodiment of the present invention; and

FIG. 6B is another cross sectional view illustrating the operation of the control valve for the water tap in accordance with the third embodiment of the present invention;

FIG. 7 is a perspective view illustrating a water saver being assembled to the control valve of the water tap in accordance with the first embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

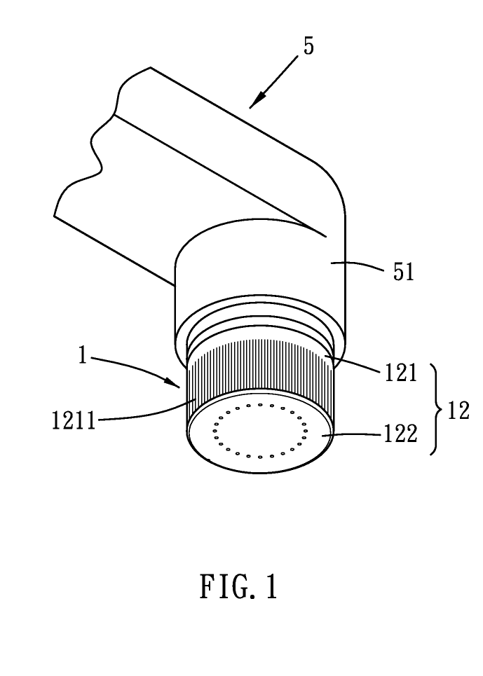

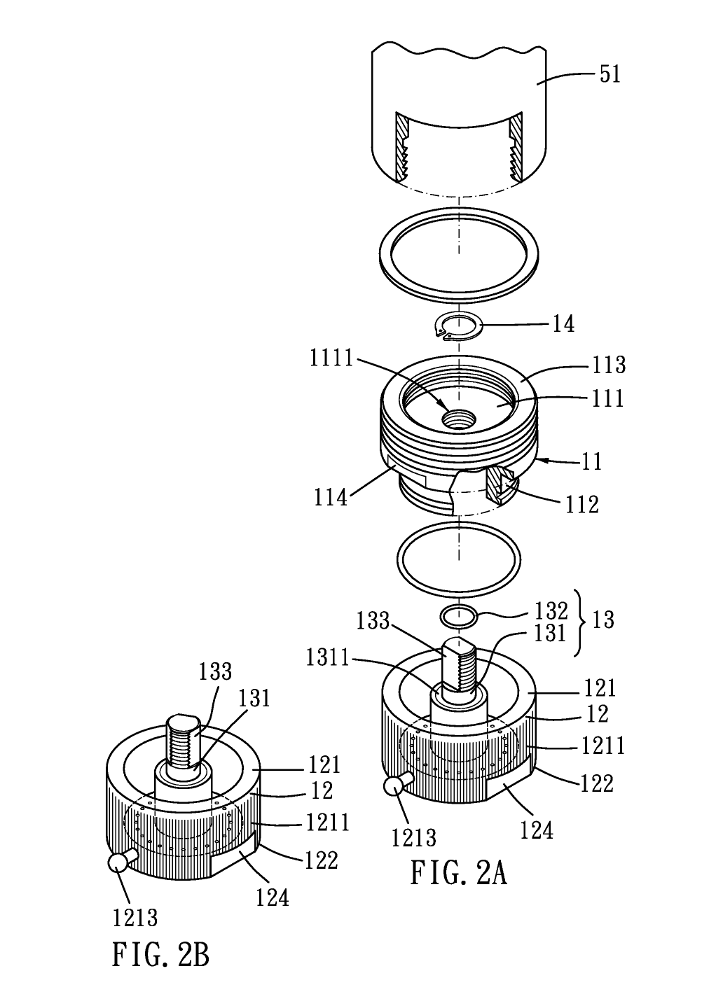

Referring to FIGS. 1 and 2A, a control valve 1 for a water tap in accordance with a first embodiment of the present invention comprises a connecting member 11, a drain member 12 and a stop assembly 13, wherein the control valve 1 is disposed on an outlet connection 51 with internal thread of a water tap 5.

As shown in FIGS. 1, 2A, 3A and 3B, the connecting member 11 includes a stop groove 111, a small-diameter portion 112, and a large-diameter portion 113, wherein the stop groove 111 includes a through hole 1111 with internal thread mounted at the center thereof, and the small-diameter portion 112 extends downward in an axial direction from the bottom of the large-diameter portion 113. Besides, the large-diameter portion 113 is axially extended upward around the stop groove 111 and includes internal and external threads formed on the inner and outer walls respectively, such that the large-diameter portion 113 of the connecting member 11 is screwed with the outlet connection 51 of the water tap 5 by using its external thread.

Furthermore, the large-diameter portion 113 of the connecting member 11 is also screwed with the outlet connection 51 with external thread (not shown) of the water tap 5 by using its internal thread, thus connecting the control valve 1 and the water tap 5 together. It is to be noted that the external and internal threads may be alternatively provided on the outer and inner rims of the large-diameter portion 113 of the connecting member 11. When the large-diameter portion 113 is eliminated from the control valve 1, the small-diameter portion 112 of the connecting member 11 still can be screwed with the outlet connection 51 of the water tap 5 by its external thread, thus connecting the control valve 1 and the water tap 5 together as well.

The drain member 12 of the control valve 1 includes an open end and a closed hollow end. The drain member 12 includes an annular cylinder 121 and a bottom 122 both affixed therein, wherein the inner diameter of the annular cylinder 121 is equal to the outer diameter of the small-diameter portion 112 of the connecting member 11 so that the small-diameter portion 112 can be inserted into the cylinder 121. In addition, a plurality of longitudinal recesses 1211 are arranged around the outer surface of the cylinder 121 so as to enhance the friction of the drain member 12 with the finger, hence the drain member 12 is easy to be rotated by the user. Moreover, a knob extension 1213 is radially attached to the cylinder 121 so that the user rotates the drain member 12 easily. Likewise, on the outer rims of the connecting member 11 and the drain member 12 are provided a plurality of first and second planes 114, 124 respectively so that the user rotates the connecting member 11 and the drain member 12 by way of a wrench (not shown), such that the connecting member 11 is engageably screwed with the outlet connection 51 of the water tap 5 and the drain member 12.

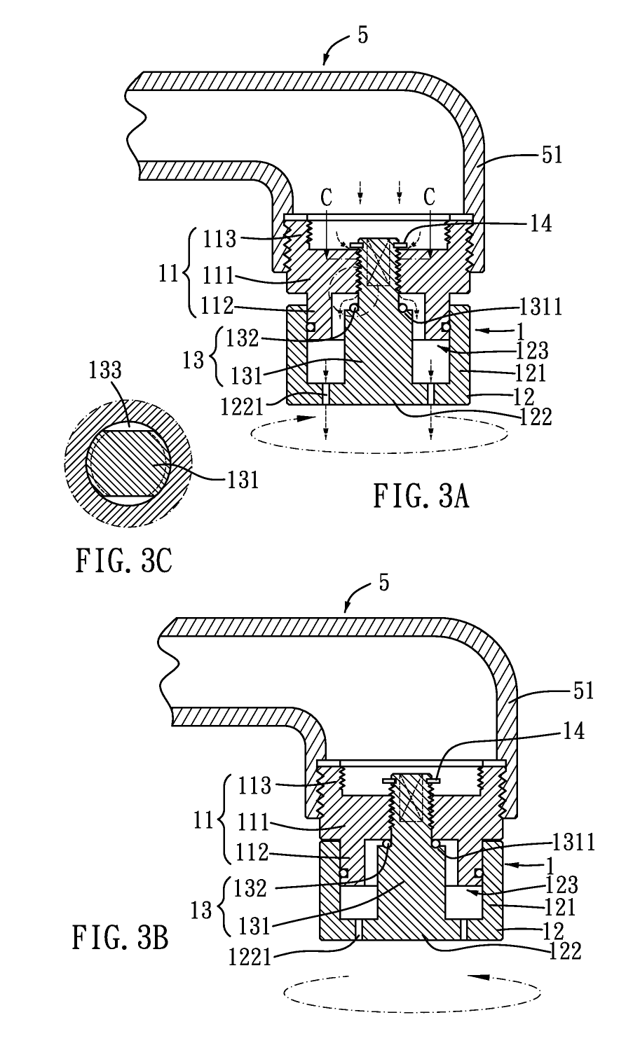

Referring further to FIGS. 2B and 3B and 3C, a control valve 1 for a water tap in accordance with a second embodiment of the present invention comprises a stop assembly 13 having a two-stepped upright shaft 131 with large-diameter and small-diameter portions and a stop washer 132, wherein the upright shaft 131 is disposed at the center of the bottom 122 of the drain member 12. It is to be noted that the upright shaft 131 is integrally formed with the drain member 12 or separately assembled into the drain member 12 in a locking manner. Besides, on the upper end of the upright shaft 131 is arranged external thread to screw the upright shaft 131 with the through hole 1111 of the connecting member 11, and the width of the small-diameter portion of the upright shaft 131 is less than that of the through hole 1111. The upright shaft 131 includes two spaced flat planes 133 fixed on the upper end thereof and axially extending along its external thread such that the external thread around the upper end of small-diameter portion of the upright shaft 131 is divided into a plurality of areas, forming a number of discrete external threads. However, the number of the flat planes 133 is not limited up to two. For example, three flat planes 133 are arranged on the upper end of the small-diameter portion of the upright shaft 131 as illustrated in FIG. 2B, wherein a passage 123 is defined among the stop groove 111, the small-diameter portion 112, the upright shaft 131, the drain member 12, and the flat planes 133. On the bottom 122 of the drain member 12 are formed a plurality of outlets 1221, each communicating with the passage 123 for flowing water outwardly, and a C-ring 14 is retained on the top end of the upright shaft 131. As shown in FIG. 3A, as rotating the drain member 12 to the first position, the C-ring 14 engages with the stop groove 111 of the connecting member 11, thus preventing overly rotating the drain member 12 to disengage from the connecting member 11. Furthermore, a retaining element may also be mounted on the top end of the upright shaft 131 so as to stop the disengagement of the drain member 12 from the connecting member 11. For example, after the upright shaft 131 is screwed with the through hole 1111, the top end of the upright shaft 131 is worked to from a retaining portion (not shown).

The upright shaft 131 further includes a peripheral rib 1311 provided on the top of the large-diameter portion thereof, and the stop washer 132 is fitted to the interface of the large-diameter and small-diameter portions of the upright shaft 131. As desiring to wash hands, the drain member 12 is rotated downward to the first position as illustrated in FIG. 3A, and then the water in the water tap 5 flows out of the outlets 1221 through the passage 123. Referring further to FIG. 3B, as desiring to stop water supply, the drain member 12 is rotated upward to the second position, and then the stop washer 132 seals the stop groove 111 and the peripheral rib 1311, closing the passage 123. Between the large-diameter portion 113 of the connecting member 11 and the outlet connection 51 of the water tap 5 is defined with a pad, and between the inner rim of the small-diameter portion 112 of the connecting member 11 and the inner rim of the cylinder 121 of the drain member 12 is provided with an O-ring to stop water flow.

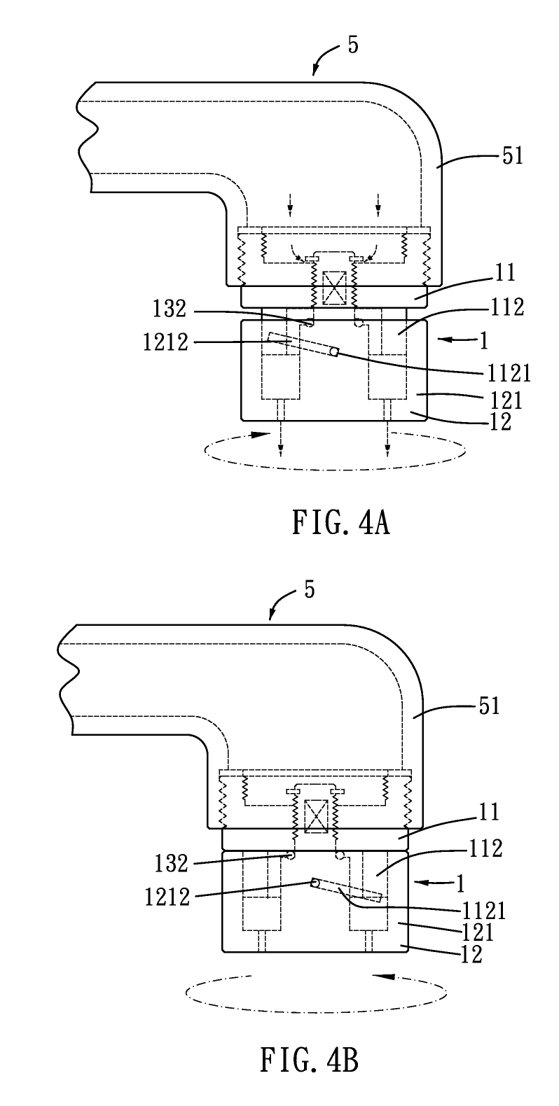

With reference to FIGS. 4 A and 4 B, on the outer rim of the small-diameter portion 112 of the connecting member 11 is fixed a projection 1121, on the inner rim of the cylinder 121 of the drain member 12 is obliquely affixed a retaining slot 1212 in which the projection 1121 is received, thereby limiting the projection 1121 to move within the retaining slot 1212. Therefore, the damage of the stop washer 132 or the disengagement of the drain member 12 can be overcome due to overly rotating the drain member 12. In addition, the projection 1121 can also be attached on the inner rim of the cylinder 121, and the retaining slot 1212 can be secured on the outer rim of the small-diameter portion 112 as well.

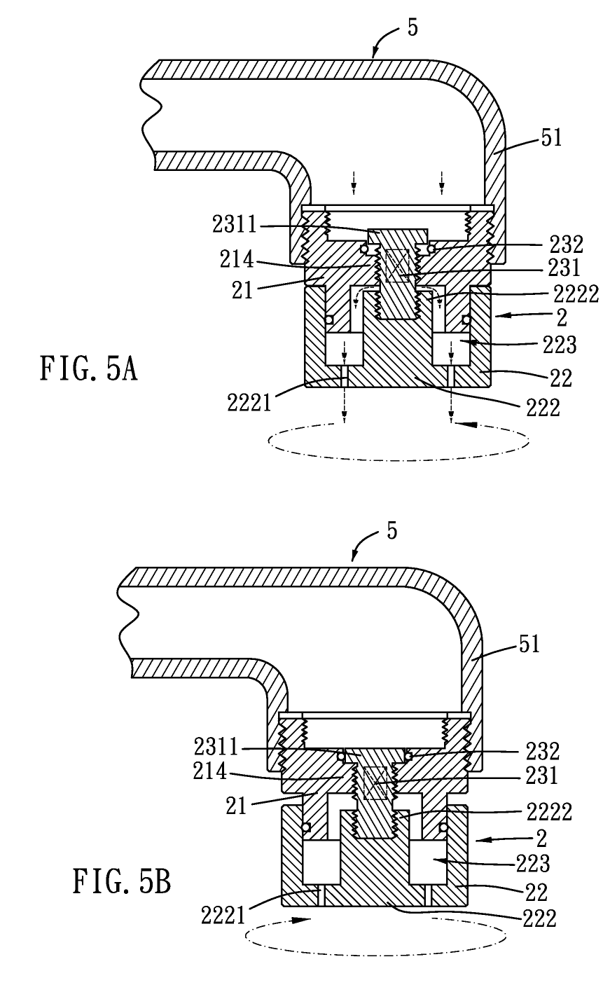

In the second embodiment of the present invention, the description related to the same components as the first embodiment of the present invention would be omitted. The different components of the control valve 1 for the water tap according to the second embodiment of the present invention from the first embodiment of the present invention includes an upright shaft 231 disposed on a bottom 222 of a drain member 22, and a connecting member 21 having a retaining portion 214 mounted in a through hole (as shown in FIG. 2A, the numeral 1111), wherein the retaining portion 214 is formed in a step shape, and a protrusion 2311 is fixed on the top of the upright shaft 231, the shape of the protrusion 2311 is in response to that of the retaining portion 214, and a stop washer 232 is defined between the retaining portion 214 and the protrusion 2311. As shown in FIG. 5A, as desiring to wash hands, the user rotates the drain member 22 upward to the first position, and then the water in the water tap 5 flows out of the outlets 2221 through a passage 223. Referring further to FIG. 5B, as desiring to stop water supply, the drain member 22 is rotated downward to the second position, and then the stop washer 232 seals the protrusion 2311 and the retaining portion 214, thus closing the passage 223 to stop water flow.

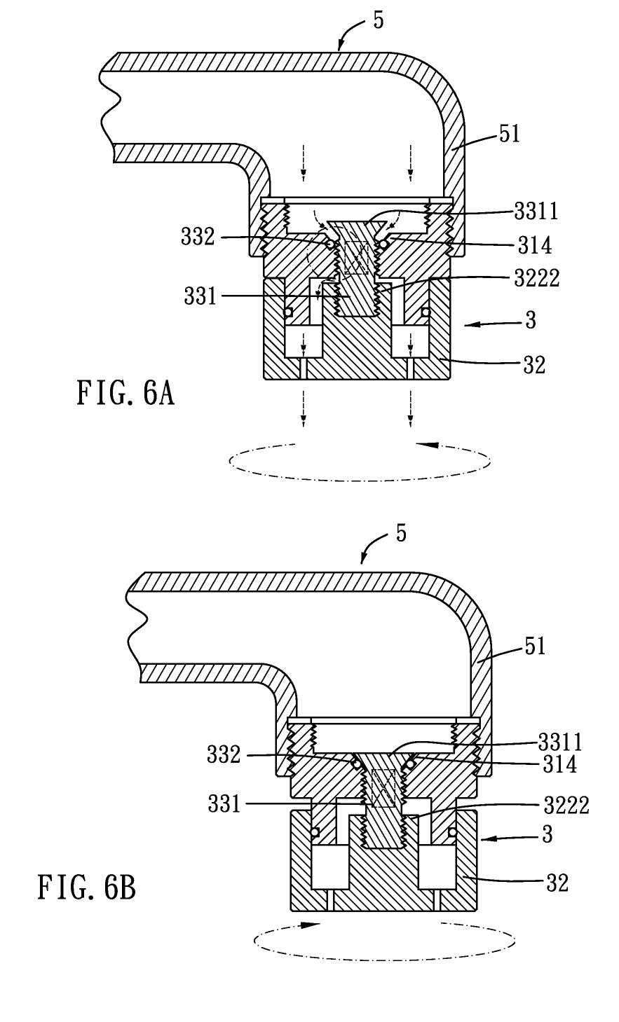

It is to be noted that the retaining portion 214 may also be formed in other shapes. For example, as shown in FIGS. 6A and 6B, a retaining portion 314 of a control valve 3 according to a third embodiment of the present invention is formed in a funnel shape, and the shape of a protrusion 3311 of an upright shaft 331 is in response to that of the retaining portion 314. Moreover, a stop washer 332 is defined between the protrusion 3311 and the retaining portion 314 so as to seal the protrusion 3311 and the retaining portion 314.

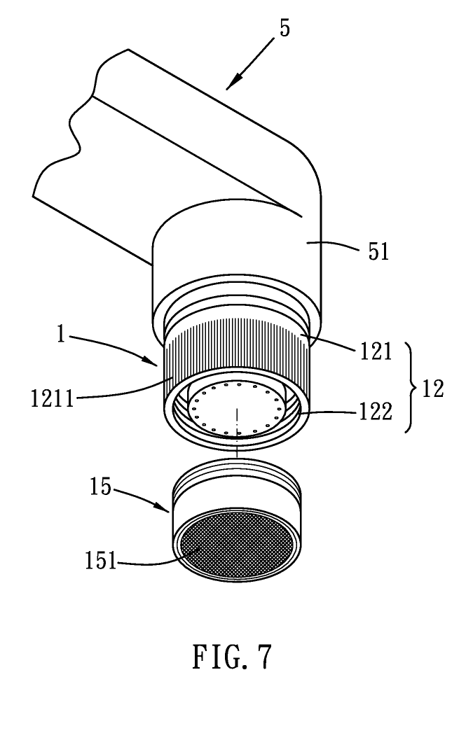

With reference to in FIG. 7, a control valve 1 for a water tap in accordance with a first embodiment of the present invention further comprises a water saver 15 screwed with the drain member 12 and including a spout 151 arranged on the bottom thereof. The passage 123, the outlets 1221, and the spout 151 are in communication with each other, such that the water and air can be mixed well to decrease the strong water spray, obtaining a water saving purpose.

While we have shown and described various embodiments in accordance with the present invention, it is clear to those skilled in the art that further embodiments may be made without departing from the scope of the present invention.

What is claimed is:

1. A control valve for a water tap comprising:
a connecting member including a large-diameter portion screwed with an outlet connection of a water tap, and including a stop groove having a through hole mounted at the center thereof, said large-diameter portion being extended upward around said stop groove; and a stop assembly including a two-stepped upright shaft and a stop washer, the width of the small-diameter portion of said upright shaft being less than that of said through hole so as to insert the small-diameter portion of said upright shaft into said through hole, and said upright shaft including flat planes fixed on the upper end thereof and axially extending along its external thread such that the external thread around the upper end of the small-diameter portion of said upright shaft is divided into a plurality of areas, forming a number of discrete external threads, and the large-diameter portion of said upright shaft communicating with a bottom of said drain member, said stop washer being defined between said stop groove and said upright shaft;
said drain member connected with said connecting member, wherein between said drain member and said connecting member is defined a passage; a plurality of outlets formed on said drain member and each communicating with said passage for flowing water outwardly;
said stop assembly defined between said connecting member and said drain member; wherein
said drain member is rotated between the first and second positions, as said drain member is rotated to the first position, the water in said water tap flows out of said outlets through said passage, and as said drain member is rotated to the second position, said stop assembly closes said passage.

2. The control valve for the water tap as claimed in claim 1 further comprising a C-ring, and said connecting member further including a small-diameter portion extending downward from said large-diameter portion, said through hole including internal thread formed therein, and on the upper end of said upright shaft is arranged external thread to screw said upright shaft with said through hole, and said stop washer being fitted to the interface of said large-diameter and small-diameter portions of said upright shaft, and said C-ring being retained on the top end of said upright shaft so that as said drain member is rotated to the first position, said C-ring engages with said stop groove.

3. The control valve for the water tap as claimed in claim 1, wherein a connecting member further includes a small-diameter portion extending downward from said large-diameter portion, said through hole includes internal thread formed therein, and on the upper end of an upright shaft is arranged external thread to screw said upright shaft with said through hole, said stop groove includes a retaining portion mounted in said through hole thereof, and a protrusion is fixed on the top of said upright shaft, the shape of said protrusion is in response to that of said retaining portion, and a stop washer is defined between said retaining portion and said protrusion, such that as a drain member is rotated to the second position, said protrusion engages with said retaining portion.

4. The control valve for the water tap as claimed in claim 1, wherein said connecting member further includes a small-diameter portion extending downward from said large-diameter portion, said through hole includes internal thread formed therein, and on the upper end of an upright shaft is arranged external thread to screw said upright shaft with said through hole, said stop groove includes a retaining portion mounted in said through hole thereof, and a protrusion is fixed on the top of said upright shaft, the shape of said protrusion is in response to that of said retaining portion, and a stop washer is defined between said protrusion and the retaining portion.

5. The control valve for the water tap as claimed in claim 3, wherein said retaining portion is formed in a step shape.

6. The control valve for the water tap as claimed in claim 4, wherein said retaining portion is formed in a step shape.

7. The control valve for the water tap as claimed in claim 3, wherein said retaining portion is formed in a funnel shape.

8. The control valve for the water tap as claimed in claim 4, wherein said retaining portion is formed in a funnel shape.

9. The control valve for the water tap as claimed in claim 2, wherein on said small-diameter portion of said connecting member is fixed a projection, on said drain member is obliquely affixed a retaining slot in which said projection is received, as said drain member is rotated to the first position, said projection engages at one end of said retaining slot, and as said drain member is rotated to the second position, said projection engages at another end of said retaining slot.

10. The control valve for the water tap as claimed in claim 3, wherein on said small-diameter portion of said connecting member is fixed a projection, on said drain member is obliquely affixed a retaining slot in which said projection is received, as said drain member is rotated to the first position, said projection engages at one end of said retaining slot, and as said drain member is rotated to the second position, said projection engages at another end of said retaining slot.

11. The control valve for the water tap as claimed in claim 4, wherein on said small-diameter portion of said connecting member is fixed a projection, on said drain member is obliquely affixed a retaining slot in which said projection is received, as said drain member is rotated to the first position, said projection engages at one end of said retaining slot, and as said drain member is rotated to the second position, said projection engages at another end of said retaining slot.

12. The control valve for the water tap as claimed in claim 1 further comprising a water saver screwed with said drain member and including a spout arranged on the bottom thereof, wherein said passage, said outlets, and said spout are in communication with each other.

13. The control valve for the water tap as claimed in claim 1, wherein a knob extension is radially attached to said drain member.
